(19) United States
(12) Patent Application Publication
(10) Pub. No.: US 2010/0244689 A1
(43) Pub. Date: Sep. 30, 2010

(54) SHORT ARC TYPE DISCHARGE LAMP

(75) Inventors: Yoshio KAGEBAYASHI, Himeji-shi (JP); Takeo MATSUSHIMA, Himeji-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: USHIO DENKI KABUSHIKI KAISHA, Tokyo (JP)

(21) Appl. No.: 12/727,707

(22) Filed: Mar. 19, 2010

(30) Foreign Application Priority Data
Mar. 27, 2009 (JP) 2009-078531

(51) Int. Cl. H01J 61/04; H01J 1/02

(52) U.S. Cl. 313/632; 313/346 R

(57) ABSTRACT

For stably supplying an electron emitting substance and preventing illuminance fluctuations, a cathode is provided made from a tungsten material containing an electron emitting substance and having a taper part a diameter of which becomes smaller towards a tip end, a tip end face formed at the tip end side of said taper part, and a fine hole extending from said tip end face in an interior of said cathode, wherein said fine hole is formed at said tip end face such that it extends over at least two tungsten crystal grains. The invention also relates to a short arc type discharge lamp comprising said cathode.

### BACKGROUND OF THE INVENTION

1. Field of the Invention

The present invention relates to short arc type discharge lamps used as light sources for the exposure used in the field of producing semiconductors or liquid crystals etc. or as light sources for projectors and digital cinemas etc.

2. Description of Related Art

Short arc type discharge lamps containing mercury have a short distance between the tip ends of a pair of electrodes arranged oppositely to each other in a light emission tube and are close to point light sources. Therefore, they are used as light sources of exposure devices with a high focusing efficiency by means of a combination with an optical system. Short arc type discharge lamps containing xenon are used as light sources of visible light in projectors etc. In recent years, they are also used as light sources for digital cinemas.

Regarding these short arc lamps, known lamps containing an electron emitting substance (in the following simply referred to as ‘emitter’) in the cathode are commonly known. For lamps having a cathode containing an emitter, lamps being provided with a fine hole to supply the emitter to the cathode are known (JP-A-11-96965).

FIG. 1 is a general view showing a short arc type discharge lamp 1, and FIG. 7 is an enlarged cross-sectional view showing the cathode in the short arc discharge lamp of JP-A-11-96965. In FIG. 1, a light emission tube 10 of the short arc type discharge lamp 1 consists of glass and comprises an approximately spherical light emission part 11 and sealing parts 12 at both ends. In a space S formed in the interior of the light emission tube 10 a pair of a cathode 20 and an anode 30 is arranged oppositely to each other. The cathode 20 and the anode 30 are configured such that a shaft part 22, 32 is inserted into a main body of a tip end. The material of the cathode 20 is tungsten which contains thorium oxide as the electron emitting substance.

As shown in FIG. 7, the cathode 20 is provided with a main body 21 at the tip end. At the rear end of the main body 21 an insertion hole 23 for the insertion of the shaft part 22 is formed. The tip end of the main body 21 has a flat tip end face 25, and in this tip end face 25 a fine hole 26 extending in the longitudinal direction of the cathode is formed. The emitter introduced into the interior of this fine hole 26 utilizes the surface diffusion of the inner peripheral surface of the fine hole 26, is released from the fine hole to the outside and is supplied to the arc.

But in recent years the problem has arisen that together with devising lamps with a high output and large sizes, the illuminance fluctuation rate at the exposure surface within a short time has increased. This is thought to be caused by an insufficient supply of the emitter from the cathode side surface to the tip end.

To solve this problem, the present inventors have produced a short arc lamp having the cathode shown in FIG. 7 and have conducted lighting tests. In JP-A-11-96965, the surface diffusion of the emitter was increased by providing a defined hole in the cathode tip end part, and it was expected that the insufficient supply of the emitter can be solved by adopting the present configuration. But also with this lamp the illuminance fluctuation rate increased. When this lamp was destructed and the cathode was analyzed it was found out that the fine hole formed in the cathode tip end part had disappeared. When the cathode main body having been cut in the longitudinal direction and having been polished was examined, it was found out that a crystal grain had clogged the exit of the fine hole. When lighting tests were performed for a lamp with the same configuration and the state of the cathode before the occurrence of the increase of the illuminance fluctuation rate was analyzed, the fine hole was on the way to be clogged but a gap was observed.

Therefore, it is assumed that the arc has become unstable because as the tip end of the cathode reaches a high temperature when lighted, the crystal grains of the tungsten grow by means of a heat transfer and clog the fine hole and there is no supply of the emitter.

### SUMMARY OF THE INVENTION

In view of the above-mentioned circumstances, a primary object of the present invention is to provide a short arc type discharge lamp wherein the electron emitting substance is supplied stably to the arc and illuminance fluctuations can be prevented by preventing that the exit of the fine hole being provided in the cathode tip end face from tungsten is obstructed because of the lighting.

To solve the above mentioned problem, the present invention is characterized in that in a short arc type discharge lamp where a pair of a cathode and an anode is arranged oppositely to each other in the interior of a light emission tube, the cathode is made from a tungsten material containing an electron emitting substance, and is provided with a taper part the diameter of which becomes smaller towards the tip end, a tip end face formed at the tip end side of the taper part, and a fine hole extending from the tip end face in the interior of the cathode, wherein the fine hole is formed at the tip end face such that it extends over at least two tungsten crystal grains.

In a second aspect, the invention relates to a cathode made from a tungsten material containing an electron emitting substance, and provided with a taper part the diameter of which becomes smaller towards the tip end, a tip end face formed at the tip end side of the taper part, and a fine hole extending from the tip end face in the interior of the cathode, wherein the fine hole is formed at the tip end face such that it extends over at least two tungsten crystal grains.

Then, the present invention is characterized in that at least a part of the inner surface of the fine hole is provided with a layer of tungsten carbide.

As, according to the present invention, the fine hole is provided in the tip end face of the cathode such that it extends over at least two crystals, the fine hole is only hardly blocked by the growth of the crystal grains and the emitter can be supplied stably to the cathode tip end part.

Then, according to the present invention, as a carbide layer is provided at least partly at the inner surface of the fine hole, the emitter being an oxide is reduced and the supply amount to the arc via the small hole can be increased.

### BRIEF DESCRIPTION OF DRAWINGS

FIG. 1 shows the schematic configuration of a short arc type discharge lamp as a whole.

FIG. 2 shows a schematic explanation of the cathode part of a short arc type discharge lamp according to a first embodiment of the present invention, FIG. 2(a) being a sectional view in the axial direction and FIG. 2(b) being a view of the cathode seen in the longitudinal direction from the tip end.

FIG. 3 is a schematic sectional view to explain the tip end part of the cathode of the present invention.

FIGS. 4(a) and 4(b) are schematic views to explain the position of the fine hole provided in the tip end part of the cathode of the present invention.

FIG. 5 shows the test results for short arc lamps of the present invention.

FIGS. 6(a) and 6(b) show explanatory partial views of the cathode of a short arc type discharge lamp according to a second embodiment of the present invention.

FIG. 7 shows a sectional view of a cathode according to a short arc type discharge lamp of the prior art.

### DETAILED DESCRIPTION OF THE INVENTION

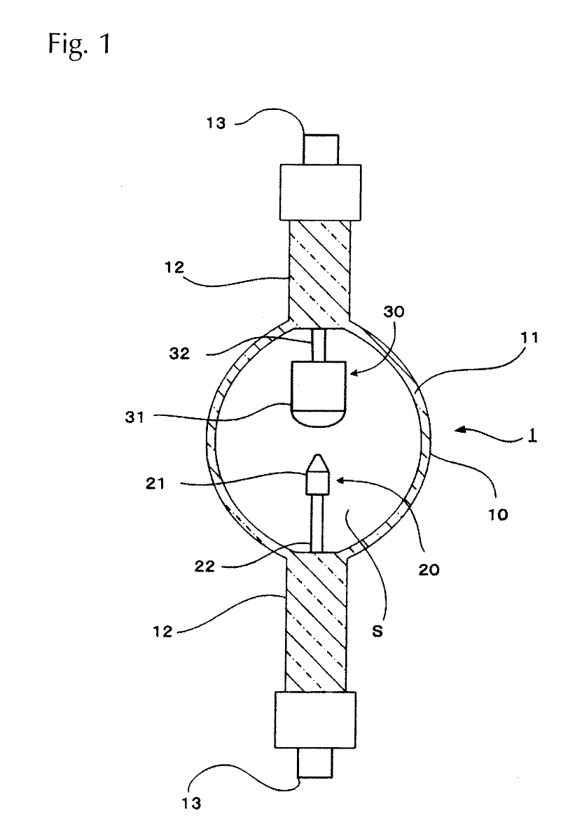

FIG. 1 shows the schematic configuration of a short arc type discharge lamp of the present invention.

The light emission tube 10 of the short arc type discharge lamp of the present invention comprises an approximately spherically shaped light emission part 11 located in the middle and columnar sealing parts 12 located at both ends. In the interior of the light emission tube 10, a main body 21 of a cathode 20 and a main body 31 of an anode 30 are arranged oppositely to each other and a light emitting substance is contained.

The cathode 20 comprises a main body 21 having a taper part the diameter of which gradually decreases towards the main body 31 of the anode 30, and a rod-shaped shaft part 22 connected to the base end side of this main body 21. The tip end part of the shaft part 22 is inserted into a bottomed hole formed in the base end side of the main body 21.

The anode 30 comprises a main body 31 with a roundness formed at the tip end side and a rod-shaped shaft part 32 connected to the base end side of the main body 31. The tip end part of the shaft part 32 is inserted into a bottomed hole formed in the base end side of the main body 31. The main bodies 21, 31 and the shaft parts 22, 32 of the cathode 20 and the anode 30 are formed by means of separate elements but it is also possible to form the main body and the shaft part integrally by means of one element.

Tungsten is used as the material for the cathode 20 and the anode 30. This tungsten material contains an electron emitting substance. The electron emitting substance is thorium oxide (ThO₂), yttrium oxide (Y₂O₃) or a lanthanoid oxide, and lanthanum oxide (La₂O₃), cerium oxide (Ce₂O₃ or CeO₂), gadolinium oxide (Gd₂O₃), dysprosium oxide (Dy₂O₃), samarium oxide (Sm₂O₃) or neodymium oxide (Nd₂O₃) etc. can be used suitably. In case of thorium oxide for example, an amount of approximately 2 wt. is contained in the tungsten. The inclusion of these electron emitting substances results in a decrease of the work function of the electrodes and in a facilitation of the electron emission.

As the tip end of the cathode is contacted by the arc, tungsten with a low density reaches a high temperature because of a bad thermal conduction, and the tip end wears off. Therefore, a density of at least 18 g/cm³ and preferably at least 19 g/cm³ is preferred for the tungsten material used for the cathode.

The enclosed main light emitting substance is mercury, and the contained amount is, for example, at least 1 mg/cm³. When mercury is contained, a rare gas, for example one or more from xenon gas and krypton gas, can be enclosed additionally as an auxiliary gas in an amount of 0.1 to 1 MPa (at room temperature). Or the enclosed main light emitting substance is a rare gas, and for example xenon gas is enclosed in an amount of 0.5 MPa (at room temperature).

In each of the sealing parts 12 at the both ends, a molybdenum foil omitted in the drawing, which is electrically connected to the shaft part of the electrode, is embedded and an air-tight structure is formed. Outer leads 13, which are electrically connected to the above mentioned molybdenum foils, project from the outer ends of the sealing parts 12. The power supply is effected by connecting an electric power supply device omitted in the drawing to the outer leads 13.

The sealing structure is not limited to the above mentioned configuration, and in case of a discharge lamp for a projector containing mainly xenon, no foil is used and the electrode shaft parts are directly sealed by a stepped glass the coefficient of thermal expansion of which is different from that of the glass used for the light emission tube.

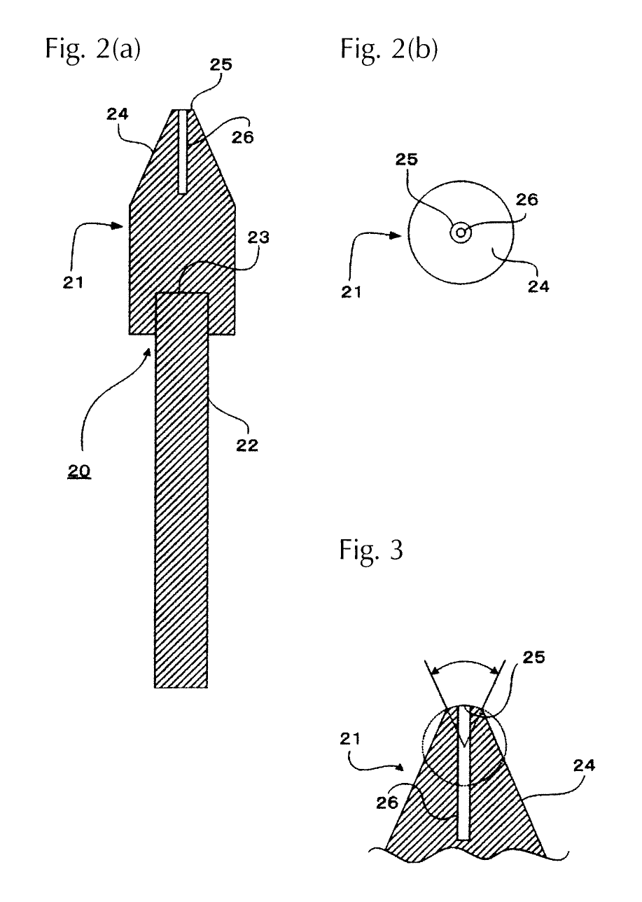

FIG. 2 is a view showing the cathode of the short arc type discharge lamp according to the first embodiment of the present invention, wherein (a) is a cross-sectional view in which the main body of the cathode is cut along the longitudinal direction, and (b) is a view of the tip end of this cathode main body seen in the longitudinal direction.

The main body 21 of the cathode 20 is approximately columnar-shaped with a larger diameter than the shaft part, 22 and is provided with a taper part 24 the diameter of which becomes smaller towards the tip end. A tip end face 25 which is formed, for example, by a flat surface is located at the tip end side of the taper part 24, and in the example of this drawing the main body 21 is formed in the shape of a truncated cone. The taper angle of the taper part 24 is 40 to 60°, and for example 60°.

The fine hole 26 has an open end in the tip end face 25 and is formed along the longitudinal direction of the cathode 20. The diameter of the tip end face 25 (in the following referred to as the ‘tip end diameter’) is 0.4 to 3 mm, and for example 1.2 mm. The inner diameter of the fine hole 26 (in the following referred to as the ‘hole diameter’) is 0.08 to 1 mm, and for example 0.1 mm, and usually a hole with a circular cross-section is easy to fabricate, but there is also no problem with a rectangular or any other suitable cross-section.

If the diameter of the fine hole is too large, the area of the tip end face decreases, the current density increases and the cathode tip end deforms easily because of a temperature increase, and the growth of the tungsten crystal grains is promoted. Therefore, the diameter is arranged within the above mentioned range.

At the base end side of the main body 21 an insertion hole 23 for the insertion of the shaft part 22 is formed and the shaft part 22 is inserted.

Besides being a flat surface, the tip end face 26 may also be a surface such as stated below.

In FIG. 3, an enlarged cross-sectional view of the cathode is shown to explain another example for the tip end face.

As shown in FIG. 3, the tip end face 28 is formed at the tip end of the cathode 20 by means of a spherical surface. Because also at this tip end face 25 an arc is formed similarly during the lighting, the same results can be obtained with regard to the forming of the fine hole 26 and the stable supply of the emitter.

The emitter contained in the cathode 20 is present in the metal in the form of an oxide. The emitter is reduced at the high temperature portion and moves from the interior of the cathode to the surface by means of a grain boundary diffusion or a transgranular diffusion, or moves in the surface by means of a surface diffusion.

With cathodes 20 having no fine hole 26, the emitter having been deposited at the taper part 24 diffuses at the surface and is supplied to the tip end face 25 of the cathode 20, but because of the high temperature in the vicinity of the tip end the major part of the emitter vanishes without being supplied to the tip end face 25. As to the emitter which reaches the tip end face 25 of the cathode 20 without vanishing, when the emitter source which had been deposited at the surface of the taper part 24 is depleted, the supply comes to a halt, a stabilized supply to the cathode tip end becomes impossible and a lack of the emitter at the tip end face 25 is caused.

If a fine hole 26 is provided in the tip end face 25, the surface in the fine hole 26 is connected to the tip end face and the opening of the fine hole 26 is also the place at which the arc is formed during the lighting. Therefore, the emitter can be supplied from the inner peripheral surface of the fine hole 26 to the arc forming position by means of a surface diffusion or a gaseous phase diffusion. Furthermore, the emitter supplied from the interior of the fine hole 26 is sent necessarily into the arc. The emitter, which has evaporated in the arc, returns again to the cathode for a positive ionization and hardly vanishes. Therefore, the fine hole 26 becomes the path for the supply of the emitter from the interior of the cathode main body 21 to the cathode tip end part, and the emitter can be supplied more stable than in the case of a supply from the outer surface of the cathode 20 up to the tip end. If the fine hole is provided in the taper part 24, the emitter sent out from there meets the same difficulties as mentioned above and a lack of the emitter is caused at the tip end face 25.

The fine hole 26 is an extremely fine hole with an inner diameter of, for example, approximately 0.1 mm, and is easily clogged, as mentioned above, by the growth of crystal grains because of the heat transfer of the tungsten. The present inventors have performed experiments such as below to solve the problem of the clogging of this fine hole.

First, a tungsten rod with a thorium oxide content of 2 wt. was cut to a specified length and was machined such that a tip end diameter of 1.2 mm and a taper angle of 60° were obtained. Then, this main body was held in a vacuum and a thermal processing at a temperature of at least 2000° C. was performed. Afterwards, the tip end face of the cathode was etched using an aqueous solution of potassium ferricyanide and sodium hydroxide and the grain boundaries were rendered easily observable.

Regarding the fine hole, a discharge machining was performed while the position was adjusted such that the hole was formed in only one crystal grain being visible at the tip end face of the cathode, and a cathode was prepared in which a fine hole with a hole diameter of 0.1 mm and a hole depth of 5 mm was formed.

By means of the same processes a discharge machining was performed while the position was adjusted such that the fine hole extended over 2 to 4 crystal grains at the tip end face of the cathode, and cathodes were prepared in which a fine hole with a hole diameter of 0.1 mm and a hole depth of 5 mm was formed.

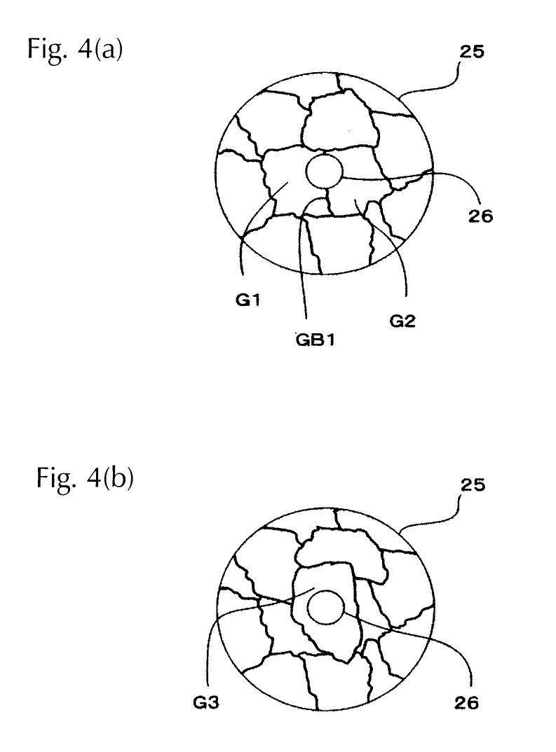

FIG. 4 is a schematic view for the explanation of the position of the fine hole 26 provided in the tip end face 25 of the cathode 20.

This drawing shows enlarged front views of the surface of the tip end face 25 of the cathode shown in FIG. 2(b), and the fine hole 26 is provided next to the center of the tip end face 25. The irregular lines rendering the tip end face 25 complicated express the grain boundaries of the tungsten crystal grains.

The cathode 20 consisting of tungsten is a piece of a plurality of metal crystal grains, and also at the surface grain boundaries are exposed.

FIG. 4(b) is a view showing a fine hole 26 extending in one crystal grain at the tip end face 25. The fine hole 26 is formed only in one crystal grain G3 and does not extend to other crystal grains.
FIG. 4(a) is a view showing a fine hole 26 extending over two crystal grains at the tip end face 25. The fine hole 26 extends over crystal grains G1 and G2 and a crystal grain boundary GB1 formed between these crystal grains.

Using these cathodes, lamps with a mercury content of 4 mg/cm³ were prepared and a lighting durability test was performed with a lamp input power of 5.5 kW. As also the lamp voltage changed when illuminance fluctuations occurred during the lighting of the lamp, simply the time until a voltage fluctuation occurred was evaluated.

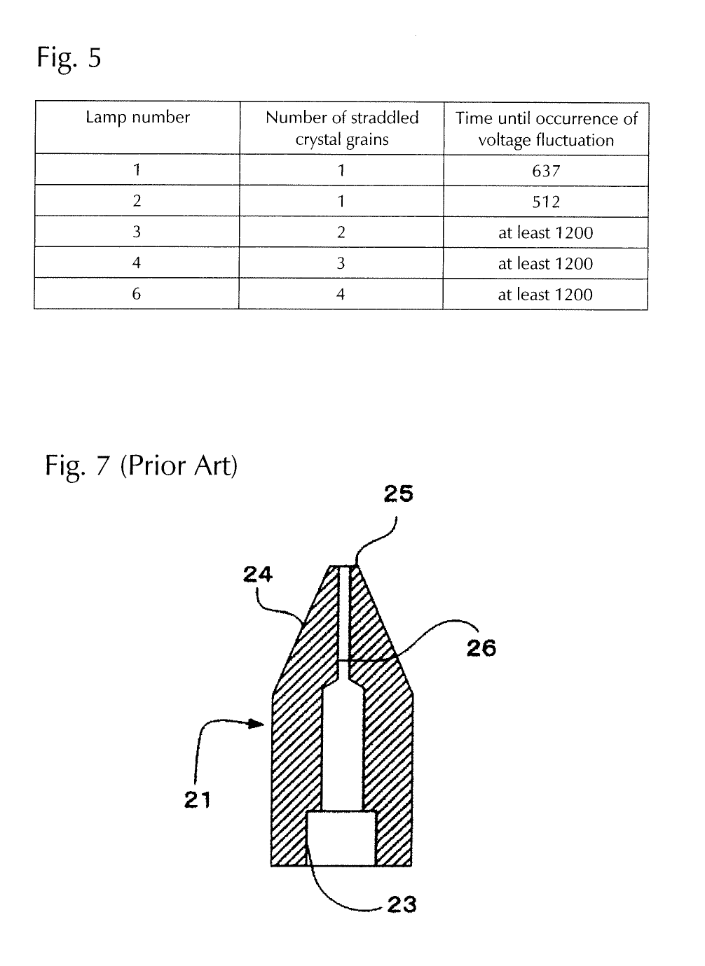

FIG. 5 is a table showing the relation between the number of crystal grains, over which the fine hole at the tip end face extends, and the time until a voltage fluctuation occurs from the start of the lighting durability test for each lamp.

For the lamps 1 and 2, the number of straddled crystal grains was 1, and therefore these were lamps having a cathode in which a fine hole was formed which did not extend over two or more crystal grains via grain boundaries. The lamps 3, 4 and 5 were lamps having a cathode in which a fine hole was formed which extended over a plurality of crystal grains. As shown in FIG. 5, for the lamps 1 and 2 a voltage fluctuation occurred at 637 hours and 512 hours respectively, while for the lamps 3, 4 and 5 no voltage fluctuation occurred even after 1200 hours had passed. Therefore it will be appreciated that there is a difference of more than twice in the illuminance fluctuation durability according to the position at which the fine hole is formed.

When the cathodes of the lamps 1 and 2 were removed and the tip end faces were examined after the end of the test, the fine hole was clogged. When these cathodes were examined after having been cut in the longitudinal direction and having been polished, the opening of the fine hole was clogged by a crystal grain.

When the tip end face of the lamp 3 was examined in the same way, it seemed that the fine hole was clogged while the grain boundary remained. When also this cathode was examined after having been cut in the longitudinal direction, crystal grains covered the opening end of the fine hole but a gap passing from the interior of the fine hole to the outside of the cathode was observed, which was thought to be the grain boundary.

From the above it seems that if the fine hole is provided only in one crystal grain, the opening of the fine hole is clogged by means of the crystal growth because of the heat transfer, and no emitter is supplied, so that the arc becomes unstable and the voltage fluctuation occurs at an early stage. If the fine hole extends over two or more crystal grains, these crystals grow and enlarge such that the fine hole is blocked, but because the grain boundaries remain, the crystal grains hardly merge and the emitter is supplied via the gaps, so that the arc is stable and no voltage fluctuations occur.

Because, as stated above, in the present invention the fine hole formed in the tungsten cathode containing an emitter is formed at the tip end face such that it extends over at least two tungsten crystal grains, the fine hole is not completely clogged, and it is possible to supply the emitter and to stabilize the arc.

Regarding the method to manufacture a cathode as mentioned above, it can, for example, also be manufactured by the method explained below.

First, a tungsten rod, to which an emitter had been added, is cut to a specified length for the cathode main body material. Then, a tip end face and a taper angle are formed at the tip end of the tungsten rod by machining. Afterwards, a fine hole is provided next to the center of the tip end face by means of a discharge processing at the tip end face. The hole diameter of the fine hole is 0.08 to 1 mm. At this stage, the shape of the main body of the cathode is completed.
Then, this main body is held in a vacuum and a thermal processing at a temperature of at least 2000° C. is performed. By means of this thermal processing, the crystal grains undergo a recrystallization and enlarge somewhat, but as the fine hole is provided before the thermal processing, the crystal grains extend over the grain boundaries also after the thermal processing. By means of forming the fine hole before the thermal processing it is possible to form a fine hole extending over at least two crystal grains even without adjusting the position for the forming of the fine hole.

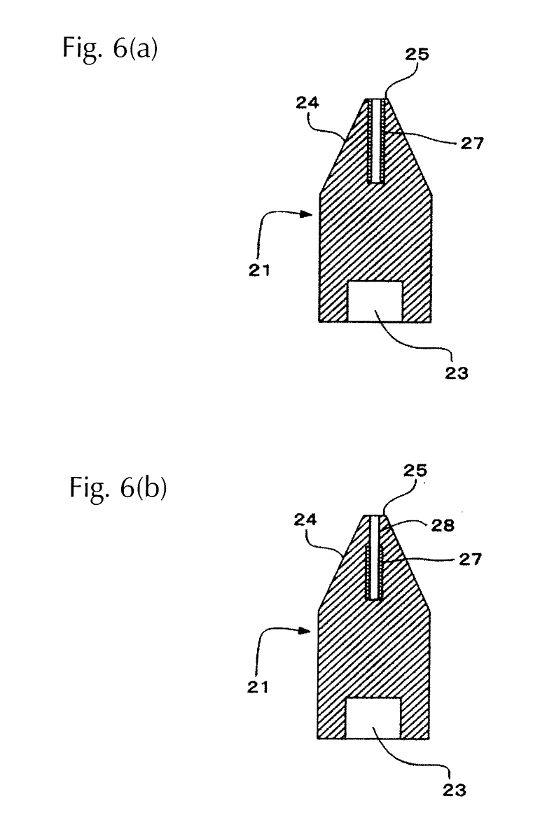

FIGS. 6(a) and 6(b) are cross-sectional views showing the cathode of a short arc type discharge lamp according to the second embodiment of the present invention. As this drawings differ from FIG. 2(a) only in that a carbide layer 27 is provided, an explanation will be omitted.

In FIG. 6(a), a carbide layer 27 is formed at the inner peripheral surface of the fine hole 26 formed in the cathode main body 21. This carbide layer 27 is a layer of tungsten carbide provided by carbonizing the tungsten being the material of the cathode. As the emitter added to the cathode is an oxide, a reduction is necessary for it to function as an emitter. Usually, the reduction is performed at the high temperature portion, but as the emitter is reduced at this tungsten carbide layer by means of the carbon at a relatively low temperature, the emitter can be supplied quickly.

In FIG. 6(b), the carbide layer 27 is not formed in the vicinity of the tip end of the fine hole 26, where a non-carbide layer 28 is present. This is to prevent that the tungsten carbide having a low melting point is melted by the arc.

It is not advantageous to provide the carbide layer 27 at an outer surface of the cathode main body 21 such as the taper part 24. The reason is that when the emitter being reduced by a tungsten carbide layer at the outer surface escapes and is released into the interior of the light emission space, it becomes the cause for cloudiness.
According to the above mentioned cathode the oxygen of the emitter being an oxide is reduced and can be supplied directly into the arc.

What is claimed is:

1. A short arc type discharge lamp, comprising
a light emission tube,
a cathode and an anode arranged oppositely to each other in an interior of the light emission tube,
said cathode being made from a tungsten material containing an electron emitting substance and having a taper part a diameter of which becomes smaller towards a tip end, a tip end face formed at the tip end side of said taper part, and a fine hole extending from said tip end face in an interior of said cathode,
wherein said fine hole is formed at said tip end face such that it extends over at least two tungsten crystal grains.

2. A short arc type discharge lamp according to claim 1, wherein the fine hole, in a direction of its diameter, extends over at least one crystal grain boundary formed between two crystal grains.

3. A short arc type discharge lamp according to claim 1, wherein a layer of tungsten carbide is provided at least partly at an inner surface of said fine hole.

4. A short arc type discharge lamp according to claim 3, wherein the layer of tungsten carbide is not provided in the vicinity of the tip end of the fine hole.

5. A short arc type discharge lamp according to claim 1, wherein an inner diameter of the fine hole is 0.08 to 1 mm.

6. A short arc type discharge lamp according to claim 1, wherein the electron emitting substance is selected from at least one of thorium oxide, yttrium oxide, lanthanum oxide and a lanthanoid oxide, such as cerium oxide, gadolinium oxide, dysprosium oxide, samarium oxide and neodymium oxide.

7. A cathode made from a tungsten material containing an electron emitting substance and having a taper part a diameter of which becomes smaller towards a tip end, a tip end face formed at the tip end side of said taper part, and a fine hole extending from said tip end face in an interior of said cathode,
wherein said fine hole is formed at said tip end face such that it extends over at least two tungsten crystal grains.

8. A cathode according to claim 7, wherein the fine hole, in a direction of its diameter, extends over at least one crystal grain boundary formed between two crystal grains.

9. A cathode according to claim 7, wherein a layer of tungsten carbide is provided at least partly at an inner surface of said fine hole.

10. A cathode according to claim 9, wherein the layer of tungsten carbide is not provided in the vicinity of the tip end of the fine hole.

11. A cathode according to claim 7, wherein an inner diameter of the fine hole is 0.08 to 1 mm.

12. A cathode according to claim 7, wherein the electron emitting substance is selected from at least one of thorium oxide, yttrium oxide, lanthanoid oxide, lanthanum oxide, cerium oxide, gadolinium oxide, dysprosium oxide, samarium oxide and neodymium oxide.
